(19) United States
(12) Patent Application Publication
(10) Pub. No.: US 2016/0152206 A1
(43) Pub. Date: Jun. 2, 2016

(54) AIRBAG DEVICE

(71) Applicant: HONDA MOTOR CO., LTD., Tokyo (JP)

(72) Inventor: Yoshiyuki Tosa, Wako-shi (JP)

(73) Assignee: HONDA MOTOR CO., LTD., Tokyo (JP)

(21) Appl. No.: 14/955,209

(22) Filed: Dec. 1, 2015

(30) Foreign Application Priority Data
Dec. 2, 2014 (JP) 2014-243938

(51) Int. Cl. B60R 21/235; B60R 21/26; B60R 21/231

(52) U.S. Cl. CPC B60R 21/235; B60R 21/231; B60R 21/26; B60R 2021/23538; B60R 2021/23509

(57) ABSTRACT

An airbag device includes an inflator that generates high-pressure gas when impact is input, an airbag body that is deployed on receiving the high-pressure gas generated by the inflator. Reinforcing fabric is sewn in a gas pressure concentration portion of base fabric of the airbag body. The reinforcing fabric is provided with an opening or the like as a tension relaxing portion for relaxing tension that acts between portions included in a sewn portion of the reinforcing fabric and the base fabric and positioned apart.

### CROSS REFERENCES TO RELATED APPLICATIONS

The present application claims priority under 35 U.S.C. §119 to Japanese Patent Application No. 2014-243938, filed Dec. 2, 2014, entitled “AIRBAG DEVICE.” The contents of this application are incorporated herein by reference in their entirety.

### BACKGROUND

1. Field

The present application relates to an airbag device with an airbag body that is deployed on receiving high-pressure gas generated by an inflator when impact is input.

2. Description of the Related Art

An airbag device equipped in a vehicle includes an inflator that generates high-pressure gas when impact is input, and an airbag body that is deployed on receiving the gas generated by the inflator. Since the temperature of the gas generated by the inflator becomes high in an early stage of the injection of the gas, a member with high heat resistance is attached to, for example, a portion inside the airbag body on which the gas pressure is concentrated (see, for example, Japanese Unexamined Patent Application Publication No. 4-169355).

In the airbag device according to Japanese Unexamined Patent Application Publication No. 4-169355, heat-resistant foam rubber is attached to a central region of base fabric of the airbag body, which faces the inflator when the airbag body is deployed. The heat-resistant foam rubber functions so as to protect the base fabric from the heat of the gas in the portion inside the airbag body on which the gas pressure is easily concentrated when the inflator generates the gas.

Although in the above-described conventional airbag device, the base fabric of the airbag body can be effectively protected from the heat of the gas of the inflator by attaching heat-resistant foam rubber to part of the base fabric of the airbag body, the necessity of attaching the heat-resistant foam rubber, which is expensive, to the base fabric of the airbag body easily causes rise in product costs.

In this regard, replacing the heat-resistant foam rubber with reinforcing fabric and attaching the reinforcing fabric to the base fabric of the airbag body by sewing (stitching) have been reviewed. However, when the reinforcing fabric is attached to the base fabric by sewing and when gas with a high temperature and high pressure is concentrated on the reinforcing fabric during the deployment of the airbag body, holes in the sewn portion might be enlarged by being pushed by the gas pressure that acts on the reinforcing fabric and the high-temperature and high-pressure gas might pass through the holes.

### SUMMARY

Thus, the present application is aimed at providing an airbag device capable of protecting base fabric of an airbag body from the heat of gas of an inflator when the airbag body is deployed and suppressing outflow of the gas of the inflator through holes in a sewn portion of the airbag body.

To address the above-described problem, an airbag device according to the present application includes an inflator (e.g. an inflator 31 in an embodiment) that generates high-pressure gas when impact is input, an airbag body (e.g. an airbag body 32 in an embodiment) that is deployed on receiving the high-pressure gas generated by the inflator, and reinforcing fabric (e.g. reinforcing fabric 45 in an embodiment) that is sewn onto base fabric (e.g., stitched to a surface of base fabric 32U in an embodiment) of the airbag body and reinforces a gas pressure concentration portion of the base fabric, the reinforcing fabric being provided with a tension relaxing portion (e.g. an opening 42 formed as a cut-off portion at the middle of the reinforcing fabric in an embodiment) for relaxing tension that acts between portions positioned apart across the sewn portion of the reinforcing fabric and the base fabric. Typically, the stitching of the sewn portion extends around on the surface of the reinforcing fabric, thereby defining at least two regions over the reinforcing fabric each located at a different side along the stitching, and the tension relaxing portion may be provided to one of the regions to relax the tension acting between the two regions so that the tension is released at the side at which the tension relaxing portion exists. When the airbag body is expanded, due to the tension relaxing portion provided to and along one region beside the stitching, the tension acting between the two regions is relaxed, and is not concentrated at the stitching. This prevents the stitching holes from being deformed or broken, and thus reduces or prevents the risk of leaking of the gas from the airbag body.

Thus, when impact is input, the inflator generates high-pressure gas and the airbag body is deployed on receiving the gas pressure. At the time, since the reinforcing fabric is sewn in the gas pressure concentration portion of the base fabric, which is inside the airbag body, the gas pressure concentration portion is protected by the reinforcing fabric from the heat and pressure of the gas of the inflator. Further, since the tension relaxing portion is provided in the reinforcing fabric, it is difficult for large tension to act between portions that are included in the sewn portion and positioned apart and for the holes in the sewn portion to be enlarged by being pushed. As a result, it is difficult for the gas of the inflator to flow outside through the holes in the sewn portion of the reinforcing fabric.

It is desirable that the sewn portion be provided in the reinforcing fabric so as to be annular and that the tension relaxing portion be an opening (e.g. the opening 42 in an embodiment) provided on an inner side of the annular sewn portion of the reinforcing fabric.

In this case, when the high-pressure gas generated by the inflator flows in a peripheral region of the reinforcing fabric along the inner surface of the airbag body, the gas is caught in the annular region of the reinforcing fabric sewn in the annular sewn portion. At the time, even when the reinforcing fabric receives the gas pressure and is pulled in any of the radial directions, the opening provided on the inner side of the annular sewn portion suppresses abrupt rise in the tension that acts on the holes of the sewn portion.

The reinforcing fabric may be provided so as to be annular near a portion included in an inner surface of the airbag body and positioned farthest from the inflator when the airbag body is deployed.

In this case, since the annular reinforcing fabric is provided in a portion in which the gas generated by the inflator flows from a peripheral region along the inner surface of the airbag body, the base fabric can be efficiently protected by the reinforcing fabric from the heat and pressure of the gas of the inflator.

### BRIEF DESCRIPTION OF THE DRAWINGS

FIG. 1 is a perspective view that illustrates the interior of a vehicle according to a first embodiment of the present application.

FIG. 2 is a sectional view of the vehicle according to the first embodiment of the present application, which corresponds to the II-II cross section in FIG. 1.

FIG. 3 is a sectional view of an airbag device according to the first embodiment of the present application, which is in a deployed state.

FIG. 4 illustrates upper-side base fabric of the airbag device according to the first embodiment of the present application, which is viewed from the inside.

FIG. 5 is an enlarged view of part V, which is indicated in FIG. 4, of the upper-side base fabric of the airbag device according to the first embodiment of the present application.

FIG. 6 is a sectional view of an airbag device according to a second embodiment of the present application, which is in a deployed state.

FIG. 7 is a perspective view of a deployment restricting member of the airbag device according to the second embodiment of the present application.

### DESCRIPTION OF THE PREFERRED EMBODIMENTS

Embodiments of the present application are described below with reference to the drawings.

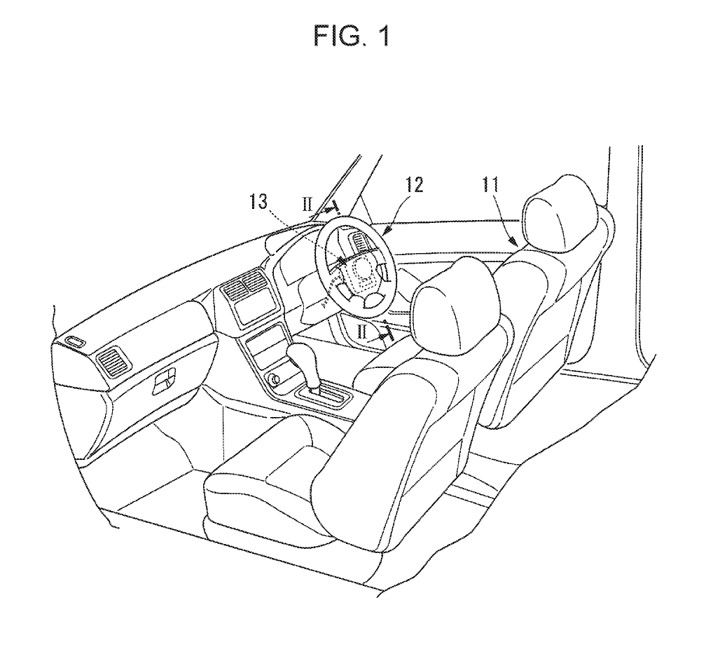

A first embodiment illustrated in FIGS. 1 to 5 is described first.

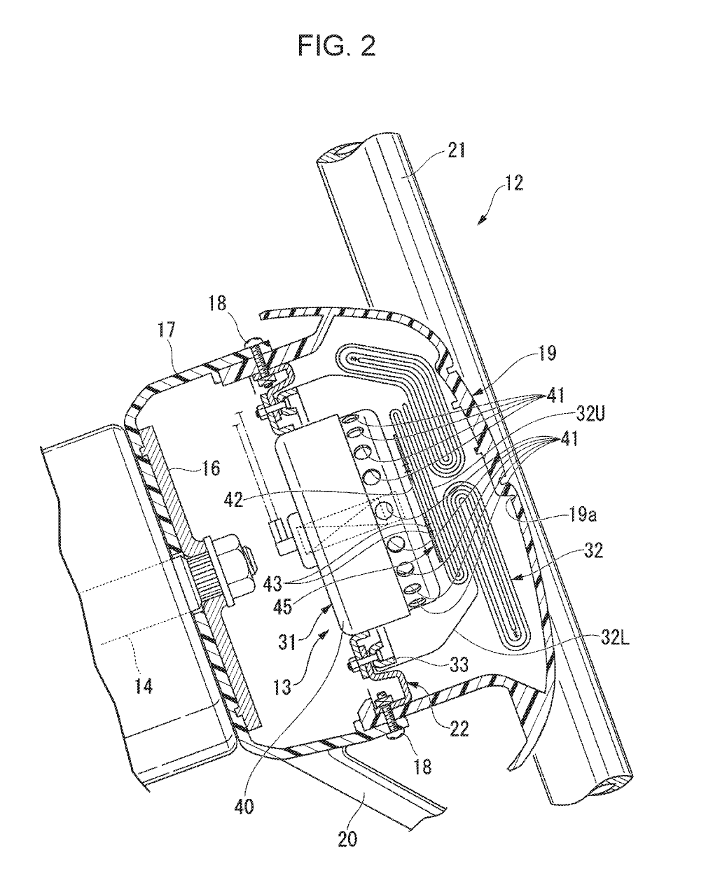

FIG. 1 illustrates the interior of a vehicle according to the first embodiment and FIG. 2 illustrates a cross section that corresponds to the II-II cross section in FIG. 1.

In FIG. 1, reference numeral 11 indicates a front seat on the driver seat side and reference numeral 12 indicates a steering wheel arranged in front of the seat 11, which is the driver seat. As illustrated in FIG. 2, the steering wheel 12 includes a boss portion 16, and the boss portion 16 is fastened and fixed to an end portion of a steering shaft 14 that projects from the front side of the vehicle interior toward the driver seat side. A rear cover 17 shaped like a cup that is opened toward the rear side of the vehicle body, that is, toward the side of the seat 11 is fixed to the boss portion 16, and the rear cover 17 is provided with a plurality of spoke portions 20 extending radially from an outer surface of the rear cover 17. A front cover 19 is attached to the rear cover 17 so as to block an opening of the rear cover 17. An annular steering wheel body 21, which is a grip portion, is coupled to end portions of the plurality of spoke portions 20.

A retainer 22, which is made of metal, is fastened and fixed to the inner circumferential surface of the front cover 19 using a plurality of bolts 18 and an airbag device 13, which is an airbag module, is attached to the retainer 22.

The airbag device 13 includes an inflator 31, which is filled with a gas generating agent for generating high-pressure gas, an airbag body 32, which is formed by sewing a lower-side base fabric 32L and an upper-side base fabric 32U together and is deployed on receiving the high-pressure gas generated by the inflator 31, and a fixing ring 33, which fixes a base portion of the airbag body 32, that is, a central portion of the lower-side base fabric 32L to the inflator 31. In the airbag device 13, a casing 40 of the inflator 31, which is shaped like an annular container, is attached to the inside of the front cover 19 via the retainer 22. The airbag body 32 is arranged on the front side of the inflator 31 in a folded state.

An inner surface of the front cover 19 is provided with a tear line 19a for promoting a break. When the airbag body 32 is deployed, the front cover 19 breaks along the tear line 19a on receiving the deployment pressure of the airbag body 32, and the airbag body 32 is caused to expand toward the side of the seat 11 through the broken portion. The outer circumferential surface of the casing 40 of the inflator 31, which is on the side close to the front cover 19, is provided with a plurality of gas injection holes 41. The high-pressure gas generated by the inflator 31 is radially injected from the casing 40 through the gas injection holes 41 of the casing 40.

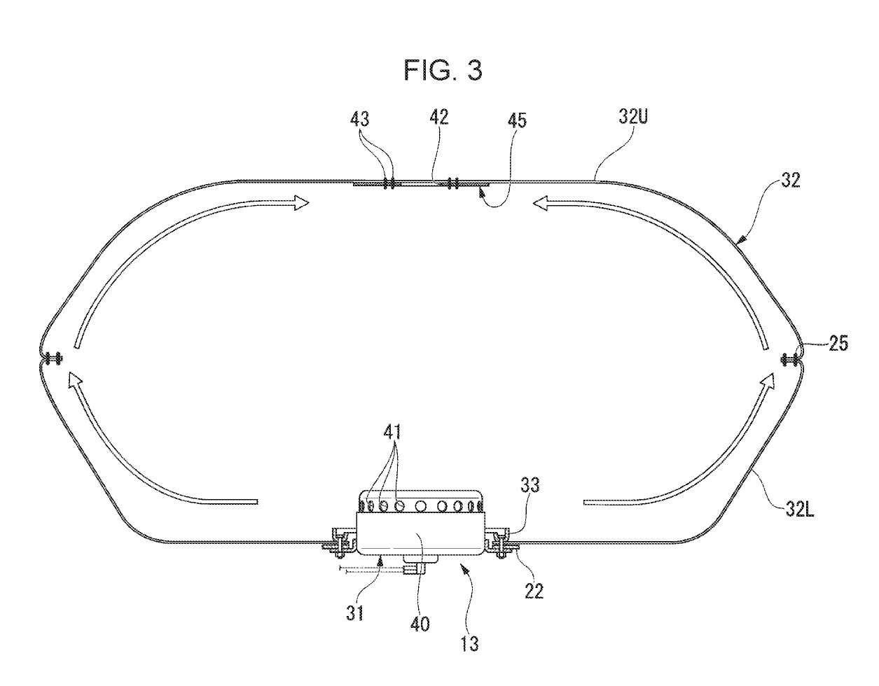

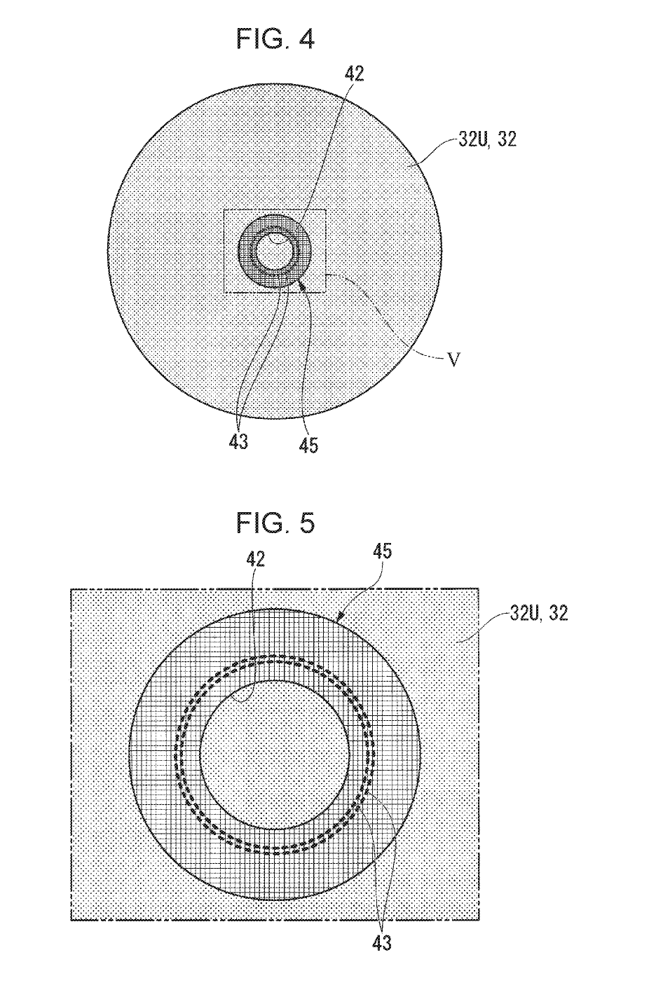

FIG. 3 illustrates a state in which the airbag body 32 of the airbag device 13 is deployed, and FIG. 4 illustrates the upper-side base fabric 32U of the airbag body 32 viewed from the inside. FIG. 5 illustrates part V in FIG. 4, which is enlarged.

The upper-side base fabric 32U and the lower-side base fabric 32L that constitute the airbag body 32 are formed so as to have an approximately circular shape, and the outer edge portions of the upper-side base fabric 32U and the lower-side base fabric 32L are mutually joined by sewing. In FIG. 3, reference numeral 25 indicates the sewn portion of the upper-side base fabric 32U and the lower-side base fabric 32L. The casing 40 of the inflator 31 is attached to an approximately central portion of the lower-side base fabric 32L.

A reinforcing fabric 45 that has a circular shape is attached to an approximately central portion of the upper-side base fabric 32U by sewing, which is on the side of the inner surface of the airbag body 32. The reinforcing fabric 45 includes an opening 42 having a shape of a circle that is approximately concentric with the circular shape of the outer edge portion, and the inner edge portion is sewn onto the upper-side base fabric 32U in an annular shape. In the present embodiment, as illustrated in FIG. 5 through enlargement, a sewn portion 43 of the reinforcing fabric 45 on the upper-side base fabric 32U is provided like an inside and outside double ring. Sealant for suppressing a gas leak from the sewn portion 43 is applied to the sewn portion 43 of the reinforcing fabric 45.

The central portion of the upper-side base fabric 32U is a portion that faces the inflator 31 almost at the front when the airbag body 32 is deployed, and is a portion in which the distance from the inflator 31 along the inner surface of the airbag body 32 is the longest. The annular reinforcing fabric 45 is attached to the approximately central portion of the upper-side base fabric 32U. When the airbag body 32 is deployed, the gas injected through the gas injection holes 41 of the inflator 31 flows along the inner surface of the airbag body 32 as indicated by the arrows in FIG. 3, and the gas pressure is concentrated on the proximity of the central portion of the upper-side base fabric 32U. Accordingly, the reinforcing fabric 45 is attached in the vicinity of the gas pressure concentration portion included in the inner surface of the upper-side base fabric 32U.

In the present embodiment, as illustrated in FIG. 2, the central portion of the upper-side base fabric 32U on the inner surface side and the reinforcing fabric 45 face the front of the inflator 31 in a state in which the airbag body 32 is folded and attached in the steering wheel 12. The airbag body 32 includes a vent hole (not illustrated), which causes part of the gas injected from the inflator 31 when the airbag body 32 is deployed to escape outside.

In the present embodiment, the opening 42 provided on the inner side of the reinforcing fabric 45 constitutes a tension relaxing portion for relaxing the tension that acts between portions that are included in the annular sewn portion 43 and positioned apart. That is, in the reinforcing fabric 45, when tension acts on any portion in the outer edge portion on receiving the gas pressure of the inflator 31, the opening 42 is subtly deformed and the tension that acts on the sewn portion 43 is relaxed.

In the above-described structure, when impact of a predetermined amount or more is input to the vehicle, the inflator 31 of the airbag device 13 generates gas instantaneously, and the generated gas is injected to the inside of the airbag body 32 through the gas injection holes 41 of the casing 40. When the gas is injected to the inside of the airbag body 32, the airbag body 32 is inflated and deployed on receiving the gas pressure, and the airbag body 32 breaks the tear line 19a of the front cover 19 to expand toward the driver seat side. As a result, the upper body of the driver caused to move toward the front side of the vehicle is caught by the airbag body 32 that has expanded from the steering wheel 12 with the effect of shock absorption.

When the airbag body 32 is deployed on receiving the gas pressure of the inflator 31, the high-temperature and high-pressure gas generated by the inflator 31 flows in the gas pressure concentration portion, which is positioned in a central region of the upper-side base fabric 32U, along the inner surface of the airbag body 32. At the time, since the reinforcing fabric 45 that is annular is sewn in the central region of the upper-side base fabric 32U, the gas is caught in the annular region of the reinforcing fabric 45 and the central region of the upper-side base fabric 32U is protected by the reinforcing fabric 45 from the heat and pressure of the gas.

While the gas is caught in the annular region of the reinforcing fabric 45, even when the reinforcing fabric 45 is pulled in any of the radial directions on receiving the gas pressure, abrupt rise in the tension that acts on the holes of the sewn portion 43 can be suppressed because of the opening 42, which is the tension relaxing portion provided on the inner side of the annular sewn portion 43. As a result, the tension that acts on the reinforcing fabric 45 makes it difficult for the holes of the sewn portion 43 to be pushed and enlarged and for the high-temperature and high-pressure gas to flow outside through the holes of the sewn portion 43.

Thus, in the airbag device 13 according to the present embodiment, the reinforcing fabric 45 enables the gas pressure concentration portion of the base fabric 32U to be protected from the heat and pressure of the gas of the inflator 31 and in addition, the tension relaxing function of the opening 42 of the reinforcing fabric 45 can suppress the outflow of the gas of the inflator 31 through the holes of the sewn portion 43.

Particularly in the airbag device 13 according to the present embodiment, since the sewn portion 43 is provided on the reinforcing fabric 45 so as to be annular and the circular opening 42 provided on the inner side of the sewn portion 43 of the reinforcing fabric 45 constitutes the tension relaxing portion, even when the reinforcing fabric 45 is pulled in any of the radial directions on receiving the gas pressure, the opening 42 provided on the inner side of the annular sewn portion 43 can suppress abrupt rise in the tension that acts on the holes of the sewn portion 43.

Further, in the airbag device 13 according to the present embodiment, the reinforcing fabric 45 is provided so as to be annular near a portion of the inner surface of the airbag body 32, which is positioned farthest from the inflator 31 when the airbag body 32 is deployed. Thus, the reinforcing fabric 45 enables the upper-side base fabric 32U to be efficiently protected from the heat and pressure of the gas generated by the inflator 31.

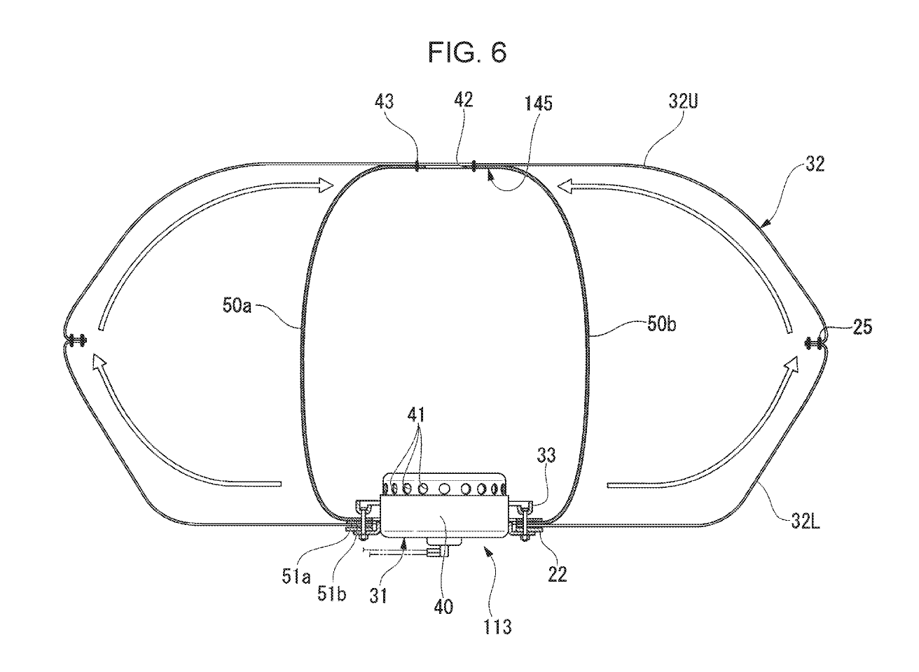

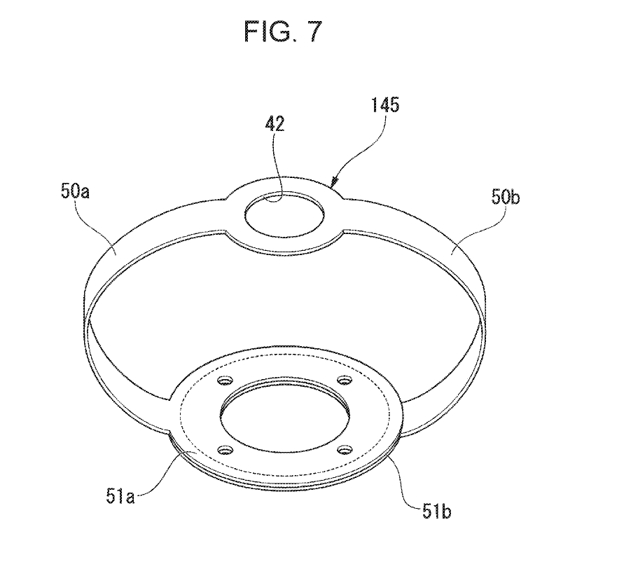

A second embodiment illustrated in FIGS. 6 and 7 is now described. The same references are given to parts the same as the parts in the first embodiment and overlapping description thereof is omitted.

In an airbag device 113 according to the second embodiment, a pair of restricting strips 50a and 50b for restricting the deployment of an airbag body 32 joins the vicinity of a central portion of a lower-side base fabric 32L and the vicinity of a central portion of an upper-side base fabric 32U together, which are included in the inner surface of the airbag body 32.

In the pair of restricting strips 50a and 50b, one end portion of the restricting strip 50a is connected to annular joined fabric 51a and one end portion of the restricting strip 50b is connected to annular joined fabric 51b while the other end portion of the restricting strip 50a and the other end portion of the restricting strip 50b are connected in common to reinforcing fabric 145. The annular joined fabric 51a and the annular joined fabric 51b are overlaid on each other and are fixed to a casing 40 of an inflator 31 together with the lower-side base fabric 32L while being fixed to the lower-side base fabric 32L. Similar to the first embodiment, the reinforcing fabric 145 is formed so as to have an approximately annular shape and an opening 42 that constitutes a tension relaxing portion is formed on the inner side of the reinforcing fabric 145. The inner edge portion of the reinforcing fabric 145 is connected to an approximately central portion of the upper-side base fabric 32U by sewing. Also in the present embodiment, a sewn portion 43 of a reinforcing fabric 45 on the upper-side base fabric 32U is provided so as to be annular. The reinforcing fabric 145 joins the other ends of the pair of restricting strips 50a and 50b to the upper-side base fabric 32U by being fixed through the sewn portion 43 to the upper-side base fabric 32U. In the present embodiment, the reinforcing fabric 145, the restricting strips 50a and 50b, the joined fabric 51a, and the joined fabric 51b are formed as an integrated deployment restricting member using fabric.

In the airbag device 113 according to the present embodiment, the reinforcing fabric 145 to which the other ends of the restricting strips 50a and 50b are connected is sewn onto the upper-side base fabric 32U so as to be annular, and the opening 42 is provided in a portion on the inner side of the sewn portion 43 of the reinforcing fabric 145. Thus, similar to the first embodiment, the reinforcing fabric 145 enables a gas pressure concentration portion of the base fabric 32U to be protected from the heat and pressure of the gas of the inflator 31 and in addition, the tension relaxing function of the opening 42 of the reinforcing fabric 145 can suppress the enlargement of holes of the sewn portion 43 due to being pushed and can suppress the outflow of the gas of the inflator 31 through the holes. Since the restricting strips 50a and 50b can suppress the thickness of the airbag body 32 at the time of deployment, for example, protecting performance in a case in which an occupant is seated at a position close to the front, which is near the position at which the airbag device 113 is provided, can be enhanced.

The present application is not limited to the above-described embodiments and various changes in design are possible within the scope not departing from the gist of the present application. For example, although each embodiment above describes an airbag device on the driver seat side, which is provided in the steering wheel, the airbag device to be applied may be an airbag device for the passenger seat or another airbag device. Further, although the outer shape of the reinforcing fabric is circular in each of the above-described embodiments, the outer shape of the reinforcing fabric is not limited to the circular shape and may be another desired shape. Moreover, the shape of the sewn portion is not limited to the continuous annular shape and may be an incontinuous linear shape. In this case, a tension relaxing portion is desirably provided by, for example, forming an opening between portions that are included in the sewn portion and positioned apart. The tension relaxing portion is not limited to the opening and may be provided as a portion that is easily deformed through expansion or contraction.

What is claimed is:

1. An airbag device comprising:
an inflator that generates high-pressure gas in response to input of collision impact;
an airbag body that is folded and housed in the airbag device and configured to be inflated and expanded upon receiving the high-pressure gas generated by the inflator, the airbag body being made of
a base fabric, and
a reinforcing fabric stitched to a portion of the base fabric at which a tension of the airbag body is concentrated due to the high-pressure gas concentrated in the airbag body when the airbag body is expanded, the stitching extending in a manner that defines at least two regions each located on a different side with respect to the stitching, the stitched portion reinforcing the portion of the base fabric against the tension,
wherein the reinforcing fabric is provided with a tension relaxing portion configured to relax the tension that acts between said at least two regions of the stitched portion.

2. The airbag device according to claim 1, wherein
the stitching is formed in an annular shape, and
the tension relaxing portion is a cut-off portion of the reinforcing fabric and the cut-off portion is surrounded by the annular stitching.

3. The airbag device according to claim 2, wherein
the reinforcing fabric is formed in an annular shape and provided to an inner surface of the airbag body at a position such that the reinforcing fabric is positioned farthest from the inflator when the airbag body is expanded.
